(19) United States
(12) Patent Application Publication
(10) Pub. No.: US 2016/0346916 A1
(43) Pub. Date: Dec. 1, 2016

(54) Corrugated Material Scribing Tool

(71) Applicant: Douglas Cox, Spur, TX (US)

(72) Inventor: Douglas Cox, Spur, TX (US)

(21) Appl. No.: 14/721,144

(22) Filed: May 26, 2015

(51) Int. Cl. B25H 7/04

(52) U.S. Cl. CPC B25H 7/04

(57) ABSTRACT

A scribing tool is provided for scribing and marking linear lines along corrugated panels. The scribing tool comprises an elongated member adapted to rest substantially flushly against a corrugated panel, whereby the flanges of the tool bear against the panel to form linear lines along which to scribe or mark for subsequent cutting. The tool comprises a cross section with a web and an upper and lower flange. The flanges include outer edges that share matching corrugated profiles therealong, whereby the first or second side of the tool can be pressed against a corrugated panel and the flanges of the tool bear flushly thereagainst. Some embodiments of the tool include a tapering height along the tool length, various cross sections that allow for different corrugated edge patterns on opposite sides of the tool, different corrugated edge patterns for specific panels, as well as male or female edge patterns.

### BACKGROUND OF THE INVENTION

1. Field of the Invention

The present invention relates to square tools and scribing tools, whereby the tool can be pressed against a work piece to scribe or mark the work piece along a straight edge. More specifically, the present invention relates to a scribing tool for corrugated panels, whereby the tool conforms to the surface pattern of the corrugated panela and provides a straight line over the pattern to facilitate scribing or marking the same.

Corrugated roofing is a popular alternative to asphalt and rubber roofing materials for several reasons. These advantages largely relate to the longevity of metal corrugated roofing panels, the ease of connection and installation of the panels on a roof, the material properties that are resistant to corrosion and combustion, and finally the overall resiliency of the panels. Corrugated roofing panels are generally galvanized metal sheets that are fitted together to form a cohesive pattern along a roof. The patterns funnel water away from the roof, while the material resists damage from the elements, as well as from animals and pests. The present invention relates to corrugated materials generally, as well as to metal corrugated roofing panels.

The present invention provides a scribing or marking tool, similar to a square tool, which facilitates marking a corrugated surface with a linear line. Marking a straight line along a corrugated panel allows a user to make straight cuts along an uneven surface without estimation or “eyeballing” the cutline. This is useful when cutting panels to a specific size, or when making cutouts to fit around objects or align with other roof structures and adjacent panels. The present invention further allows the tool to align with the given corrugated surface profile of the work piece such that the edge of the tool bears substantially flush thereagainst. Use of rulers and other squares can move and even mar the surface of the panel when scribing or marking the same.

Overall, the present invention provides a scribe tool or square tool for a corrugated work piece. The example work pieces provided in the present application represent a segment of the contemplated uses of the present invention. While corrugated roofing panels will be discussed, the present invention should not be interpreted as being limited to one application or use. Furthermore, several embodiments of the tool are disclosed. None of the embodiments shown in the figures or described as an embodiment are to be considered limiting, but are representative examples of structures falling within the scope of the claims.

### SUMMARY OF THE INVENTION

The following summary is intended solely for the benefit of the reader and is not intended to be limiting in any way. The present invention provides a new scribing or marking tool that can be utilized for marking straight lines over corrugated surfaces.

It is an object of the present invention to provide a corrugated material scribing tool having a web, an upper cap, a lower cap, a first end, a second end, and a length, whereby the edges of the caps are adapted to conform to a corrugated surface when positioned thereagainst.

Another object of the present invention to provide a corrugated material scribing tool with an upper cap having a first edge and a second edge, as well as a lower cap with a first edge and a second edge. The first edges of both the upper cap and the lower cap are on the first side of the scribing tool such that the first edges are adapted to rest against a corrugated work piece surface when the first side of the scribing tool is placed against the corrugated work piece surface.

Another object of the present invention to provide a corrugated material scribing tool with second edges disposed on both the upper cap and the lower cap along the second side of the scribing tool. The second edges are similarly adapted to rest against a corrugated work piece surface when the second side of the scribing tool is placed against the corrugated work piece surface.

Another object of the present invention to provide a corrugated material scribing tool that may have a first side with a corrugated edge pattern, and a second side with a corrugated edge pattern. The two patterns may match, be inverted, or be different corrugation patterns. Similarly, the tool may only have one side with a corrugated edge pattern, while the opposite side is flat or has another shape.

Yet another object of the present invention to provide a corrugated material scribing tool where the web, the upper cap, and the lower cap form a scribing tool with a substantially U-shaped cross section.

Another object of the present invention to provide a corrugated material scribing tool where the web, the upper cap, and the lower cap form a scribing tool with a substantially I-shaped cross section.

Another object of the present invention to provide a corrugated material scribing tool whereby the corrugated edge pattern along one or both sides of the tool comprises a plurality of peaks and valleys.

Another object of the present invention to provide a corrugated material scribing tool whereby the corrugated edge pattern along one or both sides of the tool comprises a plurality of peaks and valleys, whereby the peaks and valleys may form a female pattern to accept the male side of the corrugated work piece, or alternatively the peaks and valleys may form a male pattern that is adapted to be pressed against the female side of the corrugated work piece.

Another object of the present invention to provide a corrugated material scribing tool whereby the tool tapers from one end of the tool to the other. Specifically, the first end of the scribing tool may be taller than the second end of the scribing tool such that the scribing tool tapers from the first end to the second end along its length.

Another object of the present invention to provide a corrugated material scribing tool that further comprises an alignment bar extending substantially perpendicular to the length of the scribing tool and extending outward from the first end of the scribing tool.

Another object of the present invention to provide a corrugated material scribing tool that includes a web that comprises a plurality of aligned apertures along the length thereof for making markings along a corrugated surface.

Another object of the present invention to provide a corrugated material scribing tool

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side perspective view of the corrugated material scribing tool of the present invention.

FIG. 2 shows a view of the scribing tool being used in conjunction with a corrugated panel to mark a straight line thereacross.

FIG. 3A shows a cross sectional view of an embodiment of the present invention.

FIG. 3B shows a cross sectional view of another embodiment of the present invention.

FIG. 4A shows an example of a corrugated panel in which the present invention can be designed to match.

FIG. 4B shows an example of a corrugated panel in which the present invention can be designed to match.

FIG. 4C shows an example of a corrugated panel in which the present invention can be designed to match.

FIG. 5A shows view of the scribing tool in which female edge patterns are shown.

FIG. 5B shows view of the scribing tool in which male edge patterns are shown.

### DETAILED DESCRIPTION OF THE INVENTION

Reference is made herein to the attached drawings. Like reference numerals are used throughout the drawings to depict like or similar elements of the corrugated material scribing tool of the present invention. For the purposes of presenting a brief and clear description of the present invention, the preferred embodiment will be discussed as used for marking linear lines across corrugated panels, surfaces, and other work pieces. The figures are intended for representative purposes only and should not be considered to be limiting in any respect.

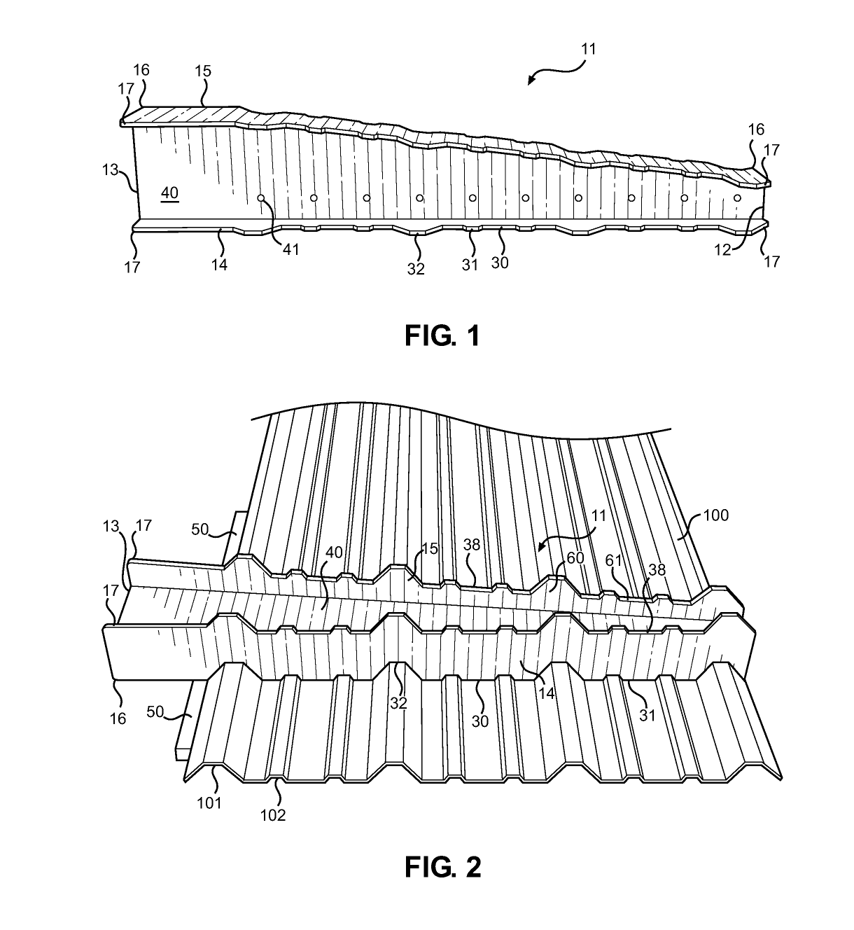

Referring now to FIGS. 1 and 2, there are shown views of the corrugated material scribing tool 11 of the present invention. The tool 11 is one that comprises an elongated length with a first end 13 and a second end 12, wherebetween the cross section of the tool allows the tool to be positioned over a corrugated surface 100 for creating linear lines over the corrugated surface 100. Several embodiments are contemplated for the cross section of the tool, whereby one or more outer edges are provided with an edge profile that matches the corrugated surface profile being scribed. In this manner, the tool is positioned against the corrugated surface and the edge profile of the tool forms a linear line that can be traced, marked, or scribed for subsequent cutting operations. The device has advantages over standard rules and straight edges, as the device conforms to specific corrugations, mostly in the field of roofing panels. However, alternate uses and alternate applications are contemplated beyond roofing panels.

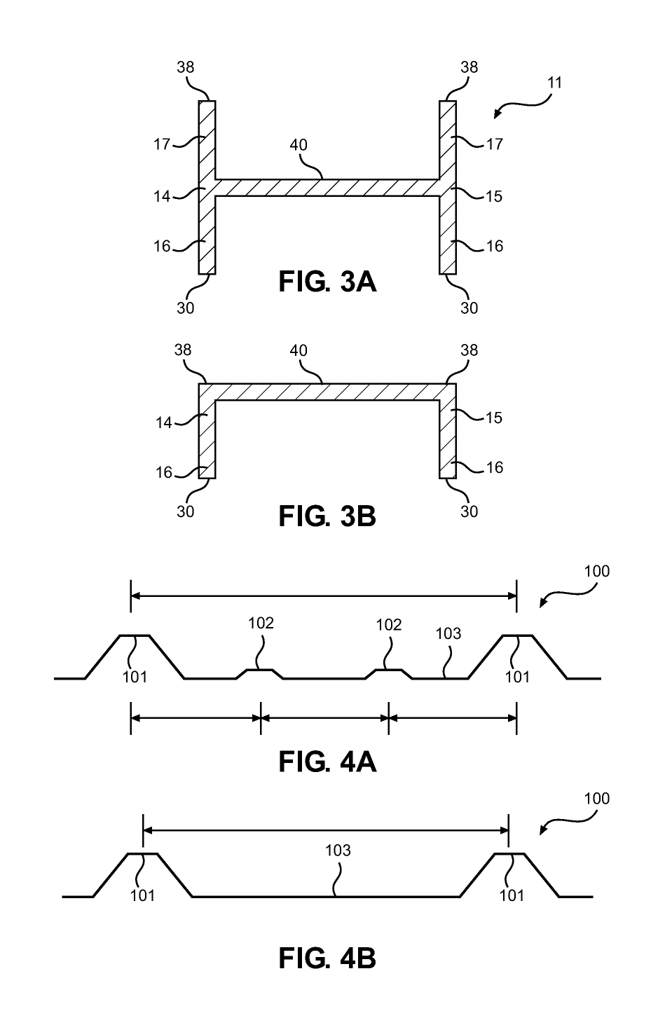

In one embodiment, the tool 11 comprises an elongated length with a web 40, an upper cap 15, a lower cap 14, a first end 13 and a second end 12. The upper cap 15 has a first edge 16 and a second edge 17, while the lower cap also has a first edge 16 and a second edge 17. The edges of the caps may be disposed away from the web 40, whereby the edges are formed from a cap that extends outward from the web 40 in the form of an outwardly extending flange. Alternatively, one side of the device may include a flange and the other side edge may be flush with the web. FIGS. 3A and 3B show one embodiment falling within this construction, whereby the tool cross section comprises an I-shape or a U-shape.

The first edges 16 of both the upper cap 15 and the lower cap 14 are disposed along a first side 30 of the scribing tool such that the first edges 16 are substantially vertically aligned and are adapted to bear against a corrugated work piece surface when the first side 30 of the scribing tool is placed thereagainst. Likewise, the second edges 17 of the upper cap 15 and the lower cap 14 may be disposed along a second side 38 of the scribing tool such that the second edges 16 are substantially vertically aligned and are adapted to bear against a corrugated work piece surface when the second side 38 of the scribing tool is placed thereagainst. However, the tool may comprise only one side in which the tool may bear against a corrugated surface 100, while the opposite side remains flat.

The outer edges of the tool on the side adapted to bear against the corrugated surface 100 has an outer edge profile that comprises a plurality of peaks and valleys to match the peaks 101 and valleys 102 of the corrugated surface 100 being scribed. Specifically, the sides of the tool may have outer edges comprises a female edge profile or a male edge profile, whereby the female edge profile is adapted to receive the corrugated surface while the male edge profile is adapted to be received by the corrugated surface. As represented in FIG. 2, the female edge profile has peaks 30 and valleys 31, 32 according to the surface profile of the corrugated surface 100. The peaks 101 of the corrugated surface 100 are received within the valleys 31, 32 of the tool edge profile. Similarly, the male edge profile has peaks 60 and valleys 61 according to the surface profile of the corrugated surface 100. The valleys 102 of the corrugated surface 100 receive the peaks 60 of the tool edge profile. While for thin sheet panels, one may flip the sheet to use either the male or female edge profile, for corrugated material that has only one exposed surface, this distinction may become important.

The outer edge profile of the tool forms a straight line across the corrugated panel 100 when placed thereagainst. In a preferred configuration, at least two outer edges along the same side of the tool are placed against the corrugated surface 100. The edges may be parallel to one another, or alternately the web 40 of the tool may taper from the first end 13 to the second end 12 such that one of the edges is angled relative to the other edge along the same side of the tool. In some embodiments, this taper may be deliberately set to a defined grade, such as a 1:12 slope line, for specific applications.

Additional features of the tool include marker hole locations 41 along the web 40 of the tool, which are used to make markings along the corrugated material 100 at desired locations. The locations of holes 41 may align with the peaks or valleys of the adjacent edge profiles of the tool along one side, whereby markings can be placed along the center of the peaks 101 and valleys 102 of the corrugated material where desired. Furthermore, the tool may comprise an edge alignment bar 50 that extends laterally from the tool and substantially parallel to the web 40. The alignment bar 50 extends substantially perpendicular to the length of the scribing tool and extends outward from the first end 13 thereof. The alignment bar 50 is useful when the edge of the panel 100 is accessible and a perpendicular marking is desired relative to the exposed edge of the panel. The alignment bar 50 is pressed against the exposed edge of the panel and the straight portion of the tool forms a perpendicular line across the panel relative to the exposed edge.

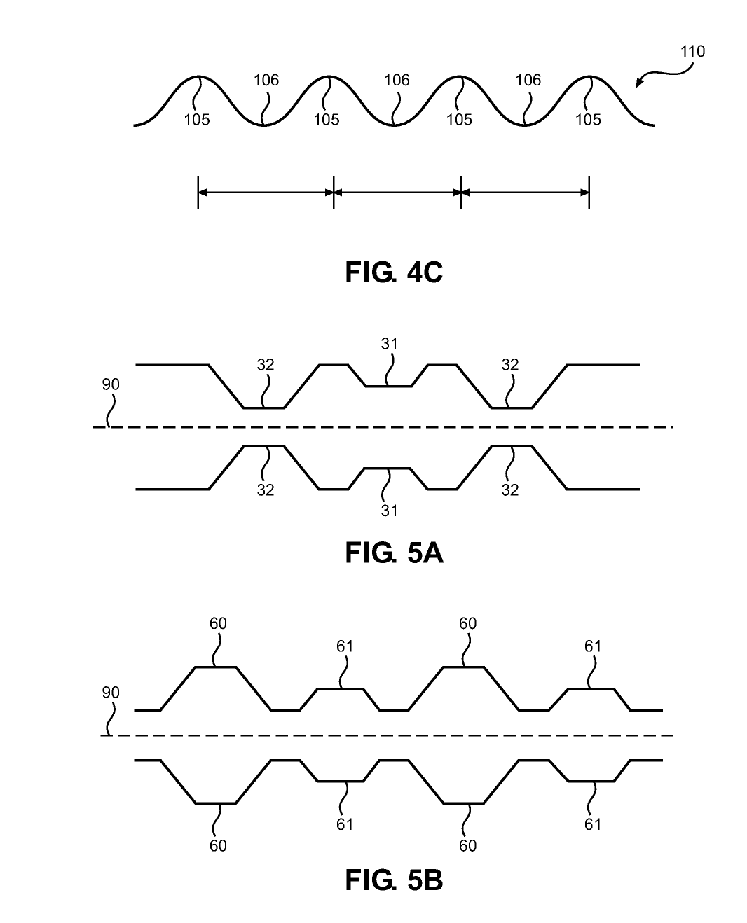

Referring to FIGS. 4A through 4C, there are shown various examples of corrugated panels 100 in which the present tool may be used in conjunction with to create linear markings therealong. The cross sections of different panels are presented, and represent merely a subset of a category of panels in which the present invention is applicable. This set is not to be considered limiting as to the edge profiles of the tool, but are presented as examples. These examples represent popular sheet panels. Panels with one exposed corrugated surface and an underlying structure are also contemplated. Some common roofing panels contemplated as defining the edge profile of the tool include: R-panels, U-panels, multi-rib panels, multi-rib PB panels, max-rib panels, multi-V panels, mega-rib panels, mini-rib panels, multi-cor panels, and meridian panels. The peaks 101, 102 and valleys 103 of the corrugated panel may be faceted, as presented in FIGS. 4A and 4B, or alternatively the peaks 105 and valleys 106 may be rounded to form a rounded profile 105 as shown in FIG. 4C. Similarly, the adjacent peaks may be equal or be of varying height relative to one another. It is not desired to limit the outer edge profile of the present tool to one corrugation profile; rather it is desired to describe and claim a tool with a plurality of peaks and valleys on at least one side of the tool that may be designed to match a specific corrugated panel design.

Referring finally to FIGS. 5A and 5B, there are shown underside views of the scribing tool of the present invention. These views show a female edge profile and a male edge profile for the same corrugation pattern. The present invention includes outer edges along one or both sides of the tool, whereby the edge profile is adapted to be a male or female pattern of the intended corrugated panel. In FIG. 5A, a female outer edge profile is provided in which the valleys 32, 31 of the profile accept the peaks of the corrugated panel therein. In the embodiment shown in FIG. 5A, the two sides of the tool share the same edge patterns and the edge patterns form mirror images of one another across the centerline 90 of the tool. However, one side of the tool may have a different edge pattern, may have an inverse pattern relative to the opposite side, or may be a flat edge. FIG. 5B shows the same corrugation pattern as 5A, however the edge pattern is inversed and the edges form a male pattern. The peaks 60, 61 of the tool are received within the valleys of the corrugated surface.

The present invention provides a tool similar to a tracing square, whereby the device is particularly suited for corrugated surfaces. The device is provided in order to draw straight lines on corrugated surfaces when making cutouts or otherwise marking straight lines on the panel surface. Current methods of marking such surfaces involve a high potential for scratching the work piece surface, and no current method allows for angled cuts as presented in the tapered embodiment herein. The present invention allows for straight and angled cuts along a corrugated surface without scratching the surface thereof.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A corrugated material scribing tool, comprising:
an elongated scribing tool having a web, an upper cap, a lower cap, a first end, a second end, and a length;
the upper cap having a first edge and a second edge;
the lower cap having a first edge and a second edge;
the first edges of both the upper cap and the lower cap being on the first side of the scribing tool such that the first edges are adapted to rest against a corrugated work piece surface when the first side of the scribing tool is placed against the corrugated work piece surface ;
the second edges of both the upper cap and the lower cap being on the second side of the scribing tool;
the first edges along the first side of the scribing tool having a matching corrugated edge profile comprising a plurality of peaks and valleys;
the matching corrugated edge profile of the first edges being adapted to match a corrugated panel.

2. The corrugated material scribing tool of claim 1, wherein:
the web, the upper cap, and the lower cap forming a scribing tool with a substantially U-shaped cross section.

3. The corrugated material scribing tool of claim 1, wherein:
the plurality of peaks and valleys form a female tool adapted to receive the corrugated work piece.

4. The corrugated material scribing tool of claim 1, wherein:
the plurality of peaks and valleys on the first side of the scribing tool form a male tool adapted to be pressed against the corrugated work piece.

5. The corrugated material scribing tool of claim 1, wherein:
the first end of the scribing tool is taller than the second end of the scribing tool such that the scribing tool tapers from the first end to the second end along its length.

6. The corrugated material scribing tool of claim 1, further comprising:
an alignment bar extending substantially perpendicular to the length of the scribing tool and extending outward from the first end of the scribing tool.

7. The corrugated material scribing tool of claim 1, whereby:
the web of the scribing tool comprises a plurality of aligned apertures along the length of the scribing tool.

8. The corrugated material scribing tool of claim 1, wherein:
the second edges of both the upper cap and the lower cap on the second side of the scribing tool are adapted to rest against a corrugated work piece surface when the second side of the scribing tool is placed against the corrugated work piece surface;
whereby the web, the upper cap, and the lower cap form a scribing tool with a substantially I-shaped cross section.

9. The corrugated material scribing tool of claim 1, wherein:
the second edges of both the upper cap and the lower cap on the second side of the scribing tool are adapted to rest against a corrugated work piece surface when the second side of the scribing tool is placed against the corrugated work piece surface;
whereby the web, the upper cap, and the lower cap form a scribing tool with a substantially I-shaped cross section;
the second edges along the second side of the scribing tool having a matching corrugated edge profile comprising a plurality of peaks and valleys;
the matching corrugated edge profile of the second edges being adapted to match a corrugated panel.

10. The corrugated material scribing tool of claim 9, wherein:
wherein the plurality of peaks and valleys on the second side of the scribing tool form a female tool adapted to be pressed against the corrugated work piece.

11. The corrugated material scribing tool of claim 9, wherein:
wherein the plurality of peaks and valleys on the second side of the scribing tool form a male tool adapted to be pressed against the corrugated work piece.

12. The corrugated material scribing tool of claim 8, wherein:
the first end of the scribing tool is taller than the second end of the scribing tool such that the scribing tool tapers from the first end to the second end along its length.

13. The corrugated material scribing tool of claim 8, further comprising:
an alignment bar extending substantially perpendicular to the length of the scribing tool and extending outward from the first end of the scribing tool.

14. The corrugated material scribing tool of claim 8, whereby:
the web of the scribing tool comprises a plurality of aligned apertures along the length of the scribing tool.
